(19) United States
(12) Patent Application Publication
(10) Pub. No.: US 2023/0061505 A1
(43) Pub. Date: Mar. 2, 2023

(54) METHOD AND APPARATUS FOR TRAINING DATA AUGMENTATION FOR END-TO-END SPEECH RECOGNITION

(71) Applicant: Electronics and Telecommunications Research Institute, Daejeon (KR)

(72) Inventors: Yoo Rhee OH, Daejeon (KR); Ki Young PARK, Daejeon (KR); Jeon Gue PARK, Daejeon (KR)

(73) Assignee: Electronics and Telecommunications Research Institute, Daejeon (KR)

(21) Appl. No.: 17/885,936

(22) Filed: Aug. 11, 2022

(30) Foreign Application Priority Data
Aug. 11, 2021 (KR) 10-2021-0106230

(51) Int. Cl. G10L 15/06; G10L 15/30; G06F 40/166; G10L 15/02

(52) U.S. Cl. CPC G10L 15/063; G10L 15/30; G06F 40/166; G10L 15/02

(57) ABSTRACT

The present invention relates to a method of training data augmentation for end-to-end speech recognition. The method for training data augmentation for end-to-end speech recognition includes: combining speech augmentation data and text augmentation data; performing a dynamic augmentation process on each of the speech augmentation data and the text augmentation data that have been combined; and training the end-to-end speech recognition using the speech augmentation data and the text augmentation data that are subjected to the dynamic augmentation process.

### CROSS-REFERENCE TO RELATED APPLICATION

This application claims priority to and the benefit of Korean Patent Application No. 10-2021-0106230, filed on Aug. 11, 2021, the disclosure of which is incorporated herein by reference in its entirety.

### BACKGROUND

### 1 Field of the Invention

The present invention relates to a technology for improving performance of end-to-end speech recognition, and to a technology for augmenting training data for end-to-end speech recognition.

### 2. Discussion of Related Art

An end-to-end speech recognition technology such as a transformer is one of speech recognition technologies that show a high success rate of speech recognition, and is a field that has been actively researched in recent years.

In a general speech recognition technology, speech recognition is performed using several models such as a pronunciation model, an acoustic model, and a language model, whereas in the end-to-end speech recognition technology, speech recognition is performed with one model. Here, end-to-end speech recognition composed of numerous parameters requires a large amount of speech and text training data.

The end-to-end speech recognition technology has a problem in that it does not fully exhibit its performance if there is not enough voice and text training data.

Therefore, in order to improve the performance of the end-to-end speech recognition, the existing data augmentation methods include various methods of augmenting speech data of training data such as a speed perturbation method, a tempo perturbation method, a vocal tract length perturbation method, and a specAugment method including noise addition, shifting trim, and pitch change.

However, the existing end-to-end speech recognition technology also requires data augmentation for speech recognition that is robust to various pronunciation modeling and language modeling features for the end-to-end speech recognition in which several models such as a pronunciation model, an acoustic model, and a language model are composed of one model. However, there is a problem in that it is not easy to arbitrarily augment data corresponding to a pronunciation model and a language model because speech data and text data are generally paired in the training of the end-to-end speech recognition.

### SUMMARY OF THE INVENTION

The present invention is directed to providing a system for training data augmentation for end-to-end speech recognition that is robust to pronunciation modeling and language modeling features by modifying and augmenting text data of training data to solve the problems of the prior art.

An aspect of the present invention is not limited to the above-mentioned aspect. That is, other aspects that are not mentioned may be obviously understood by those skilled in the art from the following specification.

According to an aspect of the present invention, there is provided a system for training data augmentation for end-to-end speech recognition including: a training database for speech recognition in which training data for speech recognition is stored; a training data separation unit for speech recognition that separates the training data for speech recognition stored in the training database for speech recognition into speech data and text data; a speech data augmentation unit that converts the input speech data into speech augmentation data through an augmentation process; a text data augmentation unit that converts the input text data into text augmentation data through the augmentation process; a data combining unit that combines the generated speech augmentation data and text augmentation data; a data dynamic augmentation unit that performs a dynamic augmentation process on each of the speech augmentation data and the text augmentation data that have been combined; and a speech recognition learning unit that trains the end-to-end speech recognition using the speech augmentation data and the text augmentation data that are subjected to the dynamic augmentation process.

The speech data augmentation unit may augment the speech data by converting a length of a speech signal of the separated speech data at a preset speed.

The speech data augmentation unit may extract speech feature data from the speech data.

The speech data augmentation unit may extract speech feature data using a Mel filter bank.

The speech data augmentation unit may augment the speech feature data by using one of specAugment methods of masking or time warping a part of a time axis and a frequency axis of the Mel filter bank which is the extracted speech feature data.

The text data augmentation unit may augment text data by using one of a method of deleting text at an arbitrary position included in the separated text data, or adding masking text to the text or substituting the masking text for the text.

The text data augmentation unit may augment text data by using one of methods of extracting text feature data from the text data, deleting text feature data at an arbitrary position among the extracted text feature data, or adding an index of a masking token to the text feature data or substituting the index of the masking token for the text feature data.

According to another aspect of the present invention, there is provided a method of training data augmentation for end-to-end speech recognition including: receiving original training data for speech recognition from a training database for speech recognition in which the original training data for speech recognition is stored; converting each of speech data and text data in the input training data for original speech recognition; converting the input speech data into speech feature data through an augmentation process; converting the input text data into text feature data through the augmentation process; combining the generated speech augmentation data and text augmentation data; performing a dynamic augmentation process on each of the speech augmentation data and the text augmentation data that have been combined; and training the end-to-end speech recognition using the speech augmentation data and the text augmentation data that are subjected to the dynamic augmentation process.

The augmentation process may include any one of processes of adding, deleting, substituting, and masking data.

In the converting of the speech data into the speech feature data through the augmentation process, the speech data may be augmented by converting a length of a speech signal of the speech data at a speed of a preset multiple.

In the converting of the speech data into the speech feature data through the augmentation process, the speech feature data may be extracted from the speech data.

In the converting of the speech data into the speech feature data through the augmentation process, the speech feature data may be augmented using one of specAugment methods of masking or time warping a part of a time axis and a frequency axis of a Mel filter bank which is the extracted voice feature data.

In the converting of the input text data into the text feature data through the augmentation process, the text data may be augmented by using one of methods of deleting text at an arbitrary position included in the text data, or adding masking text to the text or substituting the masking text for the text.

The converting of the input text data into the text augmentation data through the augmentation process may include extracting text feature data from the text data, deleting text feature data at an arbitrary position among the extracted text feature data, or adding an index of a masking token to the text feature data or substituting the index of the masking token for the text feature data.

In the combining of the speech/text data, the augmented speech augmentation data may be combined with one of “original text data” and “one or more pieces of augmented text augmentation data” for the original speech data in a pair.

According to an embodiment of the present invention, it is possible to effectively improve speech recognition performance by augmenting text training data of end-to-end speech recognition.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block configuration diagram for describing a name according to an embodiment of the present invention;

FIG. 2 is a block diagram for describing a detailed configuration of a speech data augmentation unit of FIG. 1;

FIG. 3 is a block diagram for describing a detailed configuration of a text data augmentation unit of FIG. 1;

FIG. 4 is a reference diagram for describing training data for speech recognition composed of N voice-text pairs in an embodiment of the present invention; and

FIG. 5 is a reference diagram for describing an example in which original training data for speech recognition is augmented in an embodiment of the present invention.

### DETAILED DESCRIPTION OF EXEMPLARY EMBODIMENTS

Various advantages and features of the present invention and methods of accomplishing them will become apparent from the following description of embodiments with reference to the accompanying drawings. However, the present invention is not limited to exemplary embodiments to be described below, but may be implemented in various different forms, these exemplary embodiments will be provided only in order to make the present invention complete and allow those skilled in the art to completely recognize the scope of the present invention, and the present invention will be defined by the scope of the claims. Meanwhile, terms used in the present specification are for explaining exemplary embodiments rather than limiting the present invention. Unless otherwise stated, a singular form includes a plural form in the present specification. Components, steps, operations, and/or elements mentioned by terms “comprise” and/or “comprising” used in the present invention do not exclude the existence or addition of one or more other components, steps, operations, and/or elements.

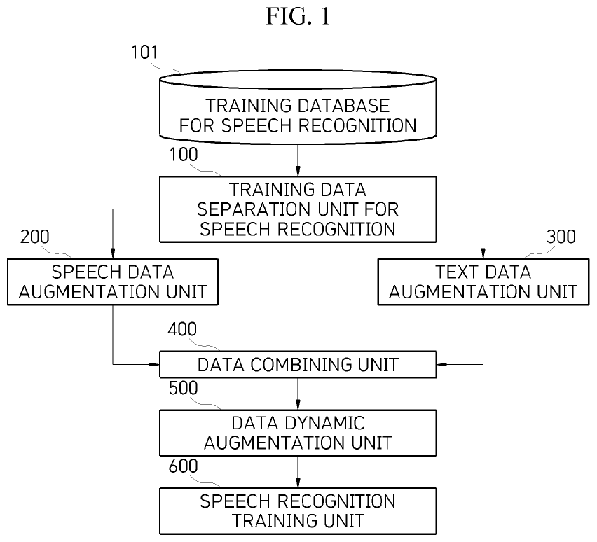

FIG. 1 is a block configuration diagram illustrating a system for training data augmentation for end-to-end speech recognition according to the present invention.

As illustrated in FIG. 1, a system for training data augmentation for end-to-end speech recognition according to an embodiment of the present invention includes a training data separation unit 100 for speech recognition, a speech data augmentation unit 200, a text data augmentation unit 300, a data combining unit 400, a data dynamic augmentation unit 500, and a speech recognition training unit 600.

The training database 101 for speech recognition stores training data for speech recognition, and provides the training data for speech recognition to the training data separation unit 100 for speech recognition.

The training data separation unit 100 for speech recognition separates the training data for speech recognition stored in the training database 101 for speech recognition into speech data and text data.

The speech data augmentation unit 200 converts the speech data separated and input by the training data separation unit 100 for speech recognition into speech augmentation data through an augmentation process. Here, the augmentation process in an embodiment of the present invention involves performing any one of processes of adding, deleting, substituting, and masking data.

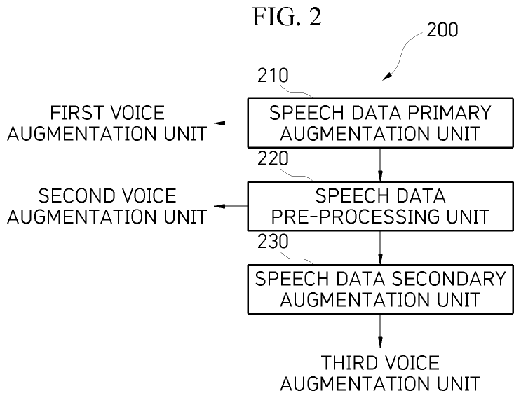

Hereinafter, a detailed process of the operation 200 of converting the input speech data into the speech augmentation data through the augmentation process will be described with reference to FIG. 2.

As illustrated in FIG. 2, the speech data augmentation unit 200 includes a speech data primary augmentation unit 210 that converts a length of a speech signal of the separated speech data at a preset speed to augment the speech data. For example, an original speech signal is augmented by applying a speed change method of converting the length of the speech signal by a factor of 0.9 or 1.1. In addition, the speech data augmentation unit 200 includes a speech data pre-processing unit 220 that extracts speech feature data from the speech data. It is preferable that the speech data augmentation unit 200 extract the speech feature data using a Mel filter bank. When the Mel filter bank is used, input speech data of a time domain is divided into frames of a 10 ms unit, and by calculating a power spectrum (or frequency) for each frame and then applying the Mel filter bank to the calculated power spectrum (or frequency), an 80-dimensional Mel filter bank value may be extracted.

In addition, the speech data augmentation unit 200 includes a secondary augmentation unit 230 that augments the speech feature data using one of specAugment methods of masking or time warping a part of a time axis and a frequency axis of the Mel filter bank which is the extracted speech feature data.

The text data augmentation unit 300 converts the input text data into text augmentation data through the augmentation process.

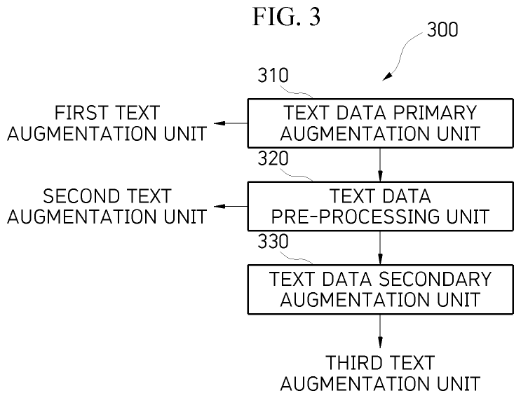

Hereinafter, a detailed process of the operation 300 of converting the input text data into the text augmentation data through the augmentation process will be described with reference to FIG. 3.

As illustrated in FIG. 3, the text data augmentation unit 300 includes a primary augmentation unit 310 that augments the text data by using one of the methods of deleting text of any position included in the text data separated by the training data separation unit 100 for speech recognition or adding masking text (for example, <unk>) to the text or substituting the masking text for the text, a text data pre-processing unit 320 that tokenizes and indexes the text data to generate the text feature data, and a text data secondary augmentation unit 330 that augments the text data by using one of methods of extracting the text feature data from the text data, deleting the text feature data at any position among the extracted text feature data, or adding an index (for example, index 1 of <unk>) of a masking token to the text feature data or substituting the index of the masking token for the text feature data.

The pre-processing unit 320 may perform a tokenization process of dividing text data into syllable units, and may convert a token string composed of text into an index string composed of numbers.

The end-to-end speech recognition depends on a text distribution of training data. As in [Table 1] below, for example, there is no training data called “from tol” in the training data.

TABLE 1

| Keyword | Training data sample |
|---|---|
| From hair | . . . from wool |
| | . . . from digital |
| | . . . from portal |
| From tol | No |

The end-to-end speech recognition generated with the training data generates an erroneous recognition result for the speech data including the text “off tol” as illustrated in [Table 2] below.

TABLE 2

| | Recognition result |
|---|---|
| Transcription | Is it faster to fall off tol now? |
| Existing recognition | Is it faster to fall off hair now? |

The text data primary augmentation unit 310 and secondary augmentation unit 330 are a process for generating a robust recognition result even if the end-to-end speech recognition deviates from the distribution of training data as described above.

[Table 3] below compares the results of the existing end-to-end speech recognition and the end-to-end speech recognition to which the text data augmentation of the present invention is applied. When recognizing the speech data including mis-vocalization (especially, “If it's wihaeuinya to find out month”), the existing speech recognition generates a character string with the highest probability among the text distributions of the training data as a recognition result. On the other hand, when the end-to-end speech recognition to which the text data augmentation of the present invention is applied is out of the text distribution of the training data, the masking text is generated as the recognition result rather than an incorrect character string.

TABLE 3

| | Recognition result |
|---|---|
| Transcription | Once this is now wihaeuinya to find out |
| | month |
| Existing recognition | Once this now depends on Korean won |
| Application of | Once this is now Monday and Tuesday |
| augmentation of the | <unk> <unk> <unk> |
| present invention | |

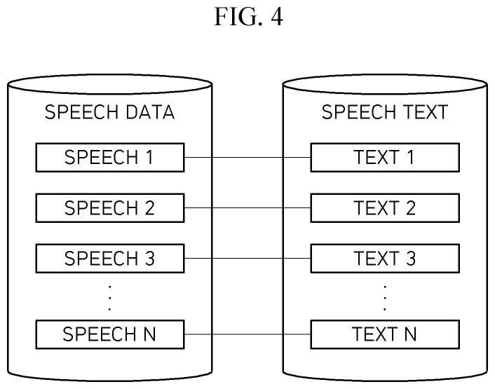

The data combining unit 400 combines the speech augmentation data converted by the speech data augmentation unit 200 and the text augmentation data converted by the text data augmentation unit 300. As an example, it is assumed that the training data for speech recognition composed of N speech-text pairs is as illustrated in FIG. 4.

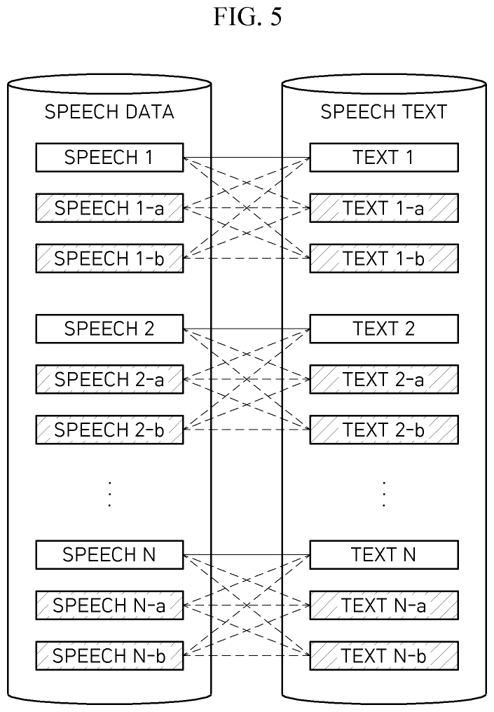

In the case where the augmentation by the speech data primary augmentation unit 210 and the speech data secondary augmentation unit 230 is applied to the speech data, and the augmentation by the text data primary augmentation unit 310 and text data secondary augmentation unit 330 is applied to the text data is described as an example, as illustrated in FIG. 5, the original speech data is augmented to 3 times the amount of data, and the original text data is augmented to 3 times the amount of data. After that, the augmented speech and text are combined to augment data to 27 times the amount.

While the above example is a case where all of the augmentation methods described in the present invention are applied, the augmentation methods may be selectively applied.

The data dynamic augmentation unit 500 may perform the dynamic augmentation process on each of the speech augmentation data and the text augmentation data that have been combined.

The speech recognition training unit 600 trains the end-to-end speech recognition using the speech augmentation data and text augmentation data that is subjected to the dynamic augmentation process.

Each step included in the method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Hereinabove, although the configuration of the present invention has been described in detail with reference to the accompanying drawings, this is merely an example, and those skilled in the art to which the present invention pertains can make various modifications and changes within the scope of the technical spirit of the present invention. Accordingly, the scope of protection of the present invention should not be limited to the above-described embodiment and should be defined by the description of the claims below.

What is claimed is:

1. A system for training data augmentation for end-to-end speech recognition, the system comprising:
a training database for speech recognition in which training data for speech recognition is stored;
a training data separation unit for speech recognition that separates the training data for speech recognition stored in the training database for speech recognition into speech data and text data;
a speech data augmentation unit that converts the input speech data into speech augmentation data through an augmentation process;
a text data augmentation unit that converts the input text data into text augmentation data through the augmentation process;
a data combining unit that combines the generated speech augmentation data and text augmentation data;
a data dynamic augmentation unit that performs a dynamic augmentation process on each of the speech augmentation data and the text augmentation data that have been combined; and
a speech recognition learning unit that trains the end-to-end speech recognition using the speech augmentation data and the text augmentation data that are subjected to the dynamic augmentation process.

2. The system of claim 1, wherein the speech data augmentation unit augments the speech data by converting a length of a speech signal of the separated speech data at a preset speed.

3. The system of claim 1, wherein the speech data augmentation unit extracts speech feature data from the speech data.

4. The system of claim 3, wherein the speech data augmentation unit extracts speech feature data using a Mel filter bank.

5. The system of claim 4, wherein the speech data augmentation unit augments the speech feature data by using one of specAugment methods of masking or time warping a part of a time axis and a frequency axis of the Mel filter bank which is the extracted speech feature data.

6. The system of claim 1, wherein the text data augmentation unit augments text data by using one of a method of deleting text at an arbitrary position included in the separated text data, or adding masking text to the text or substituting the masking text for the text.

7. The system of claim 1, wherein the text data augmentation unit augments text data by using one of methods of extracting text feature data from the text data, deleting text feature data at an arbitrary position among the extracted text feature data, or adding an index of a masking token to the text feature data or substituting the index of the masking token for the text feature data.

8. A method of training data augmentation for end-to-end speech recognition, the method comprising:
receiving original training data for speech recognition from a training database for speech recognition in which the original training data for speech recognition is stored;
converting each of speech data and text data in the input training data for original speech recognition;
converting the input speech data into speech feature data through an augmentation process;
converting the input text data into text feature data through the augmentation process;
combining the generated speech augmentation data and text augmentation data;
performing a dynamic augmentation process on each of the speech augmentation data and the text augmentation data that have been combined; and
training the end-to-end speech recognition using the speech augmentation data and the text augmentation data that are subjected to the dynamic augmentation process.

9. The method of claim 8, wherein the augmentation process includes performing any one of processes of adding, deleting, substituting, and masking data.

10. The method of claim 8, wherein, in the converting of the speech data into the speech feature data through the augmentation process, the speech data is augmented by converting a length of a speech signal of the speech data at a speed of a preset multiple.

11. The method of claim 8, wherein, in the converting of the speech data into the speech feature data through the augmentation process, the speech feature data is extracted from the speech data.

12. The method of claim 11, wherein, in the converting of the speech data into the speech feature data through the augmentation process, the speech feature data is augmented using one of specAugment methods of masking or time warping a part of a time axis and a frequency axis of a Mel filter bank which is the extracted voice feature data.

13. The method of claim 8, wherein, in the converting of the input text data into the text feature data through the augmentation process, the text data is augmented by using one of methods of deleting text at an arbitrary position included in the text data, or adding masking text to the text or substituting the masking text for the text.

14. The method of claim 8, wherein the converting of the input text data into the text augmentation data through the augmentation process includes extracting text feature data from the text data, deleting text feature data at an arbitrary position among the extracted text feature data, or adding an index of a masking token to the text feature data or substituting the index of the masking token for the text feature data.

15. The method of claim 8, wherein, in the combining of the speech/text data, the augmented speech augmentation data is combined with one of “original text data” and “one or more pieces of augmented text augmentation data” for the original speech data in a pair.
